(19) United States
(12) Patent Application Publication
(10) Pub. No.: US 2005/0091657 A1
(43) Pub. Date: Apr. 28, 2005

(54) Fuzzy logic based intelligent load control for multimedia and telecommunication systems

(75) Inventor: Xavier Priem, Siquay Perros (FR)

Correspondence Address: Siemens Corporation;Intellectual Property Department, 170 Wood Avenue South, Iselin, NJ, 08830, US

(73) Assignee: Siemens Aktiengesellschaft, Muenchen (DE)

(21) Appl. No.: 10/502,437

(22) PCT Filed: Jan. 23, 2003
(86) PCT No.: PCT/EP03/00685

(30) Foreign Application Priority Data
Jan. 24, 2002 (EP) 02001720.8

(51) Int. Cl. G06F 9/46

(52) U.S. Cl. 718/104; 718/105

(57) ABSTRACT

A load control system for a Multi-Application/Process Multimedia&Telecommunication System is disclosed. A typical Internet Services Server does not provide any support to limit the rate of connections per second and/or the rate of requests per second to dynamically adapt to server load and/or satisfy a policy constraint on service guarantees. As a result, it is likely for an Internet Services Server to become saturated (overloaded) when servicing content to clients. In an overloaded condition, a typical server suffers severe performance degradation, with the overall throughput falling significantly and client connectivity and perceived performance such as the delay in completing the request) becoming unpredictable. The invention solves these problems by a mechanism which is based on the use of a fuzzy logic expert system. The fuzzy logic expert system computes in a first step (NOM, Normal OperationMode) an overload level (load monitoring and overload detection) for the system according to the monitored resources (like CPU, memory, Ios, queues . . . ) and to a predefined fuzzy logic rule-based scenario. If a defined overload level is reached, then the FLEXSYS (Fuzzy Logic EXpert SYStem) computes in a second step (OOM, Overload Operation Mode) which overload handling actions (overload handling) have to be taken (according to a second FLEXSYS scenario).

### CROSS REFERENCE TO RELATED APPLICATIONS

This application is the US National Stage of International Application No. PCT/EP03/00685, filed Jan. 23, 2003 and claims the benefit thereof. The International Application claims the benefits of European application No. 02001720.8 filed Jan. 24, 2002, both of the applications are incorporated by reference herein in their entirety.

### FIELD OF INVENTION

The invention relates to a method for controlling overload of a data processing system.

### BACKGROUND OF INVENTION

Load control plays an important role for telecommunication and computer systems.

For telecommunication products and data networks value-added IP (Internet Protocol) services become more and more important and show new needs in terms of performance and reliability. This is the reason why the running environment of these services has to be realized for carrier-grade scaling and availability. Solid overload detection and handling mechanisms are the precondition for an optimized use of the resources and a higher robustness of the system.

A typical Internet Services Server does not provide any support to limit the rate of connections per second and/or the rate of requests per second to dynamically adapt to server load and/or satisfy a policy constraint on service guarantees. As a result, it is likely for an Internet Services Server to become saturated (overloaded) when servicing content to clients. In an overloaded condition, a typical server suffers severe performance degradation, with the overall throughput falling significantly and client connectivity and perceived performance (such as the delay in completing the request) becoming unpredictable.

In addition to susceptibility to overload, current servers lack the ability to monitor the incoming load and differentiate between different types of services, especially in scenarios such as virtual hosting in which multiple services (e.g., different Internet service applications) may be co-located on the same server platform. Without overload protection and service differentiation, a typical server would only be able to provide “best effort” service to its customers.

To combat overload following two approaches are common:
1. Usually a predefined threshold (determined during load test in a test-lab) is defined per application (number of parallel sessions, maximal number of waiting events in the queue or more generic resources like CPU or memory use) and the given application rejects all new incoming load if this threshold is reached.
2. Another method is to add a Load Balancer before the considered machine in order to tail the incoming load between a given set of similar machines. In this method, the threshold used in 1. is used in this extra-machine. Load Balancing is more used in order to avoid rejecting new incoming load. It does not solve overload for a single machine.

### SUMMARY OF INVENTION

The invention's objective is to propose an efficient load control mechanism.

The present invention features a method for controlling overload of a data processing system. According to said method comprising a load of said data processing system is monitored, whereby parameters for a degree of utilisation of resources (e.g. CPU load, memory utilisation, I/O load) of said data processing system are determined. Further, an overload operation mode (OOM) of said data processing system is run. The overload operation mode includes following steps:
a) said parameters are fed into a fuzzy logic expert system, which comprises a fuzzy rule base having rules and associated fuzzy logic variables;
b) important rules among said rule base are identified in accordance with said parameters via said fuzzy logic expert system;
c) values for the fuzzy logic variables are calculated, which are associated with the important rules.

The handling the overload is based on the identified rules and the calculated values of said associated fuzzy logic variables.

In one embodiment, the method further comprises the step of running a normal operation mode (NOM) of said data processing system. The load of said data processing system may also be monitored in the normal operation mode. Monitoring in the normal operation mode may comprise the same steps as in the overload operation mode, i.e.
a) parameters are determined for said degree of utilisation of resources of said data processing system in both the normal operation mode and the overload operation mode;
b) said parameters are fed into said fuzzy logic expert system;
c) additional application specific parameters are determined, which refer to the degree of utilisation of resources by applications running on said data processing system, in the overload operation mode; and
d) said application specific parameters are fed into said fuzzy logic expert system.

The output of the fuzzy logic expert system may be put to use for providing a criterion for switching between the normal operation mode and the overload operation mode. To this end, an overload level may be determined via said fuzzy logic expert system based on said parameters and/or said application specific parameters, and overload level may be used as the criterion for switching between the normal operation mode (NOM) and the overload operation mode (OOM).

The monitoring of the load of said data processing system may be performed with a frequency, which is higher in the overload operation mode than in the normal operation mode.

The method may be implemented on different kinds of platforms or computer systems. For instance, telecommunication systems may conduct overload control via the present method. In particular, switching systems that deal with data packets may benefit from an optimized load control. The invention can also be used to provide Web Servers with intelligent load control. Centralized differentiated QoS (quality of service) aware Call Admission Control for new Soft-switches is another possible area of deployment.

The invention allows for the development of control mechanisms and policies for commercial platforms such that the respective platform (i) tracks and avoids non-manageable overload situations before they set in (predictive fuzzy logic rules in the NOM), (ii) avoids also short overload picks (transient fuzzy logic rules in the NOM), and (iii) provides service differentiation between different applications based on specified policies (application specific fuzzy logic rules in the OOM).

With such support a server may become self-sufficient in preventing overload and can dynamically configure the control mechanisms provided to obtain the desired performance effects. One of the advantages of this approach is that no additional or new equipment needs to be deployed separately to provide similar capabilities.

Further, this permits existing server installations to be upgraded in an application and network transparent manner, i.e., without deeply modifying applications or existing network connectivity.

Another significant advantage is that the control settings provided can be used to track an overload situation as it unfolds, generating notifications or control actions as necessary. This greatly simplifies administration and capacity planning for a server, and by extension for a server farm, thereby reducing system management costs and complexity. This is also applicable to proxies, front-end servers etc.

The provided fuzzy logic programming language authorizes all levels needed for a precise tuning of the overload handling. There is no limit for the granularity of the overload decision and overload treatment models.

Furthermore, the idea to use the results of the rules calculation in combination with the output variables calculation allows a simple description of overload actions to be specially taken. Because a rule describes a precise mix of overload conditions like common resources overflow, application specific queues overflow, this same rule can be taken as decision base for overload handling actions. Every new recognized overload situation can be introduced in the fuzzy logic expert system database and actions can be taken according to it.

The proposed fuzzy logic toolbox allows for giving different priorities to the rules used for the overload status calculation. This permits different levels of precision in the overload calculation. More important rules get a higher priority factor.

The proposed fuzzy logic toolbox also allows for dynamic changes. That means, it is possible to couple it to self-learning mechanisms like neuronal networks in order to develop a self-adaptive overload control expert system.

An embodiment of the present invention will now be described with reference to the following figures:

### BRIEF DESCRIPTION OF THE DRAWINGS

FIG. 1: Fuzzy Logic Based Load Control System for Multimedia/Telecommunication Platforms

FIG. 2: Operation modes of the LMP (NOM/OOM)

FIG. 3: COPL: CPU load level and its fuzzy equivalent level

FIG. 4: COPL: Memory charge level and its fuzzy equivalent level

FIG. 5: COPL: I/Os usage level and its fuzzy equivalent level

FIG. 6: Fuzzy Logic applied to NOM

FIG. 7: a typical (and very true) rule example

FIG. 8: NOM fuzzy inference engine

FIG. 9: Fuzzy variable cpu (sets)

FIG. 10: definition of the CPU fuzzy variable using fuzzy sets

FIG. 11: NOM fuzzy variables

FIG. 12: output of all the rules within the fuzzy model

FIG. 13: accumulation of the output variable

FIG. 14: Fuzzy Logic applied to OOM

FIG. 15: OOM fuzzy inference engine

FIG. 16: output of all the rules within the fuzzy model

### DETAILED DESCRIPTION OF INVENTION

The embodiment of the invention relies on a flexible and adaptable overload detection and overload handling mechanism.

This mechanism is based on the use of a fuzzy logic expert system. This fuzzy logic expert system computes in a first step (NOM, Normal Operation Mode) an overload level (load monitoring and overload detection) for the system according to the monitored resources (like CPU, memory, Ios, queues . . . ) and to a predefined fuzzy logic rule-based scenario. If a defined overload level is reached, then the FLEXSYS (Fuzzy Logic EXpert SYStem) computes in a second step (OOM, Overload Operation Mode) which overload handling actions (overload handling) have to be taken (according to a second FLEXSYS scenario).

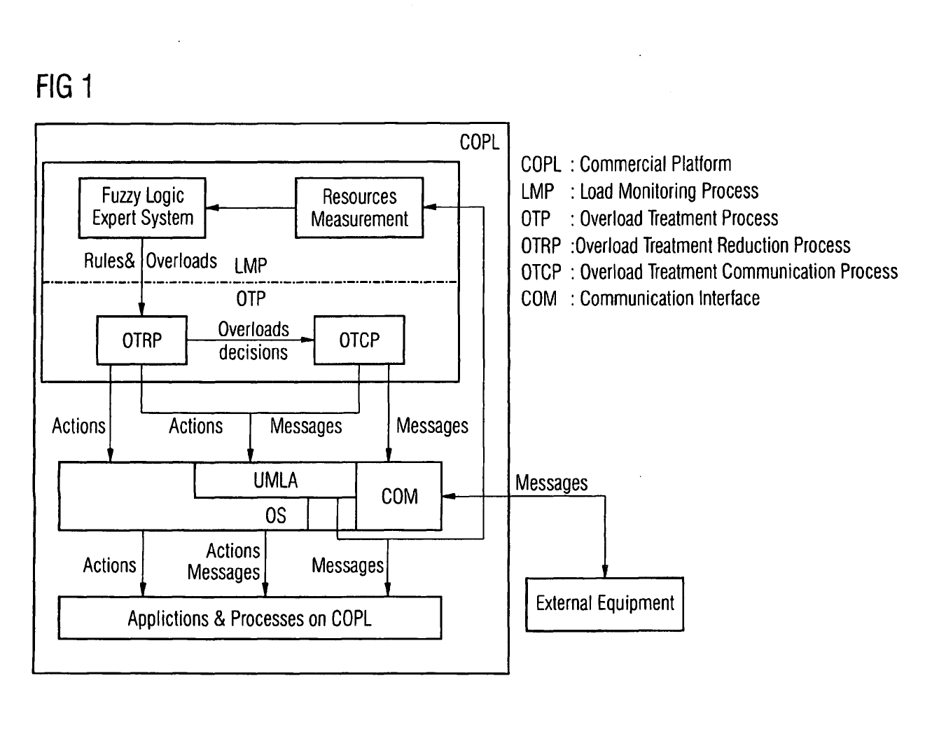

The complete load control system can be seen in FIG. 1.

In view of an improved readability the description of the embodiment is divided into the below sections:

1 Realization

1.1 Overload Detection

1.1.1 Local COPL Overload Detection
1.1.1.1 Load Monitoring Process
1.1.1.2 Monitored resources
1.1.1.2.1 CPU (NOM/OOM)
1.1.1.2.2 MEMORY (NOM/OOM)
1.1.1.2.3 I/O (NOM/OOM)
1.1.1.2.4 OVERALL SYSTEM OVERLOAD (NOM/OOM)
1.1.1.2.5 APPLICATIONS SPECIFIC RESOURCES (OOM only)
1.1.1.2.6 Transient Parameters (NOM/OOM)
1.1.1.3 The Normal Operation Mode (NOM)
1.1.1.3.1 Overview of fuzzy logic used in NOM
1.1.1.3.2 Fuzzification stage
1.1.1.3.3 Inference process
1.1.1.3.4 Defuzzification
1.1.1.3.5 COPL Overload level
1.1.1.4 The Overload Operation Mode (OOM)
1.1.1.4.1 Overview of fuzzy logic used in OOM
1.1.1.4.2 COPL Overload level
1.1.1.4.3 Application/process specific overload level
   1.2 Overload Treatment
1.2.1 Local COPL Overload Treatment
1.2.1.1 Overload Treatment Process (OTP)
1.2.1.1.1 Overload Treatment Reduction Process (OTRP)
1.2.1.1.1.1 Overload treatment identification
1.2.1.1.1.1 Internal Strategies of Load Rejection and Reduction
1.2.1.1.2 Overload Treatment Communication Process (OTCP)
1.2.1.1.2.1 Communicating Overload Level to COPL Applications
1.2.2 Communicating Overload Level to Other Platforms
1.2.3 Applications Overload Treatment

It has been chosen to develop and implement fuzzy logic based load control on the so-called Commercial Platform (COPL) which relies on a SUN™ machine running Sun's Solaris ™ v2.6 (in future v8) operating system.

The system described below takes into account the fact that the COPL deals with other kinds of applications than traditional PSTN (public switched telephone networks) systems do. These applications are from two groups: a first group that defines the Open Service Platform (OSP) and a second group that defines the Packet Control Unit (PCU). All these applications deal with IP-networks and IP-services. They need other measurements and handling mechanisms than the one used in processes running on traditional PSTN switching systems.

1 Realization

The invention relies on a flexible and adaptable overload detection and overload handling mechanism. This mechanism is based on the use of a fuzzy logic expert system. This fuzzy logic expert system computes in a first step (NOM, Normal Operation Mode) an overload level (overload detection) for the system according to monitored resources (like CPU, memory, Ios, queues, etc.) and to a predefined fuzzy logic rule-based scenario. If a defined overload level is reached, then the FLEXSYS (Fuzzy Logic EXpert SYStem) computes in a second step (OOM, Overload Operation Mode) which overload handling measures (overload handling) have to be taken (according to a second FLEXSYS scenario).

The complete fuzzy logic based load control system, which can be implemented in multimedia and telecommunication platforms, is shown in FIG. 1.

1.1 Overload Detection

Overload detection encompasses a set of stages like local and remote resources load monitoring, calculation of an overall overload level, system status switching and start of the overload treatment.

1.1.1 Local COPL (Commercial Platform) Overload Detection

Like in CP load control, the COPL overload levels rank from 1 to 6.

However, in contrast to the concept of CP overload control there are no explicit load states defined for the COPL, i.e. the COPL is considered not to be under overload if the “over-” load level is set to 0. (Nevertheless the transition between the level 0 and level 1 is treated differently than the transition between on to the other levels (1 . . . 6).)

1.1.1.1 Load Monitoring Process

The COPL's operating system (e.g. UNIX, SUN Solaris) consists of applications and processes that are called by the kernel (endless loop) depending on their priority. In this environment, the LMP (Load Monitoring Process) should run as a single process. It should be quick and time interrupt driven. It should get a higher priority but not use more than a predefined amount of memory and CPU time pro run (budget defined in Erl).

The LMP has to monitor different kinds of resources:

CPU usage
Memory usage
I/O usage
Overall System Overload
Applications specific resources
   The LMP must have two running modes:
a basic one in non-overloaded operation in order to detect an overload situation by checking a restricted amount of main resources like cpu, memory and ios,
an overload mode running under overload situation, which makes a more detailed analysis of the overload situation and that runs with a higher frequency and checks an higher amount of resources (not only cpu, memory and ios, but also application specific ones).

Under normal situation, the LMP (load monitoring process) only checks the operating status of the whole system and, in case of detection of a possible overload situation, switches to its overloaded mode.

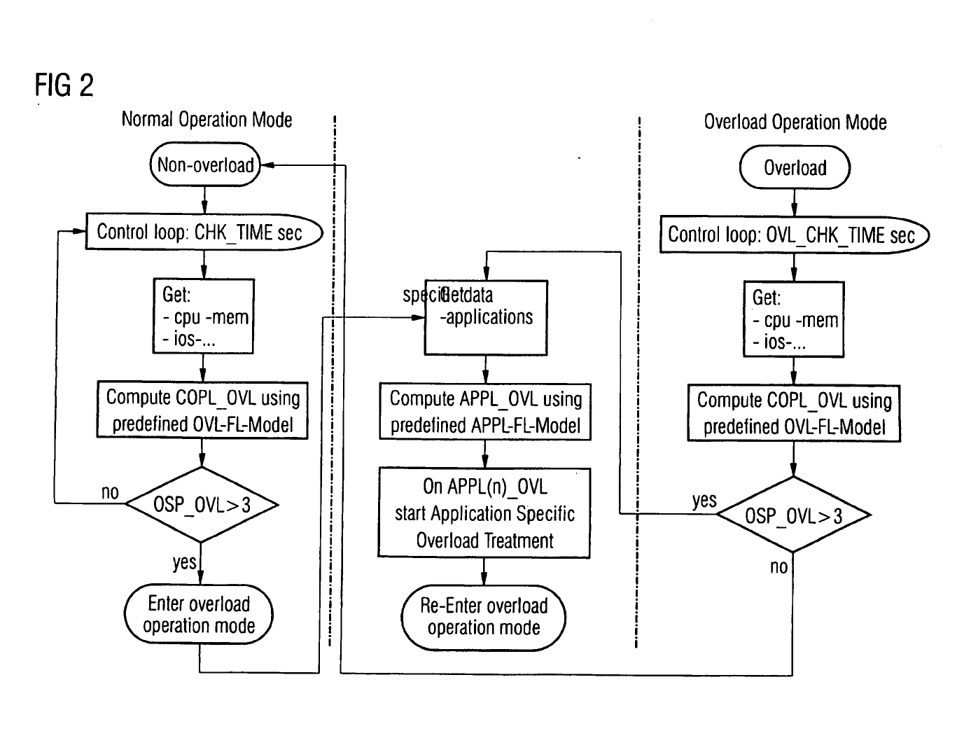

In overloaded mode, the LMP checks the same way as the basic mode but with a higher frequency, a second time-loop checks extra resources in order to possibly detect the overload responsible application. The operation modes of the LMP (NOM/OOM) are shown in FIG. 2.

The left part of the Overload Operation Mode (OOM) is very similar to the Normal Operation Mode (NOM); the main difference is the control loop frequency. If the chosen programming technique allow it, the two processes could be merged into one (with two threads).

The NOM should be a light process, checking a restricted fix amount of main resources. It is not correlated to the running applications on the COPL. It says if the COPL (globally) should enter the OOM. This part of the LPM is the same for all versions of the COPL, like for example the PCU or the OSP. It can rely on an optimized Fuzzy Logic Kernel running in C or Assembler (for higher speed). Its configuration can be adapted through its FL-Model configuration file (like a script or database). An other aspect is that the NOM conserves some values between its runs and uses them to eliminate some kinds of problems like short-time overloads that do not require an overload treatment. Typically the NOM calculates the “climbing factor” or increase/decrease coefficient (df/dt).

The OOM is should stay a light process (not more than 50% more resource consumption than the NOM), checking a higher amount of resources (the same as NOM and additional application specific resources). It relies on a Fuzzy Logic driven expert system that can compute which measures have to be taken in order to drive the COPL back to the NOM. Its configuration can be adapted through its FL-Model configuration file (like a script or database). A kind of overload responsibility check is performed by the OOM. According to the results, some signals are sent and actions are taken to the diverse components of the COPL. It decides how the Overload Treatment has to work. The OOM FL-Model depends on the applications running on the COPL.

1.1.1.2Monitored Resources

1.1.1.2.1 CPU (NOM/OOM)

The global CPU load (in opposition to the process cpu load) can be checked using standard OS functions or UMLA API. The returned value is a percentage of the whole cpu capacity (in a further step, it could be a per-cpu measurement in case of multiple cpu). Before using this raw measurement, it can be useful to go through an intermediate state, making the cpu raw measurement correspond to a cpu overload level (OVL_CPU). This intermediate statement is mostly useful if the NOM does not rely on Fuzzy Logic, indeed the FL performs automatically such conversions.

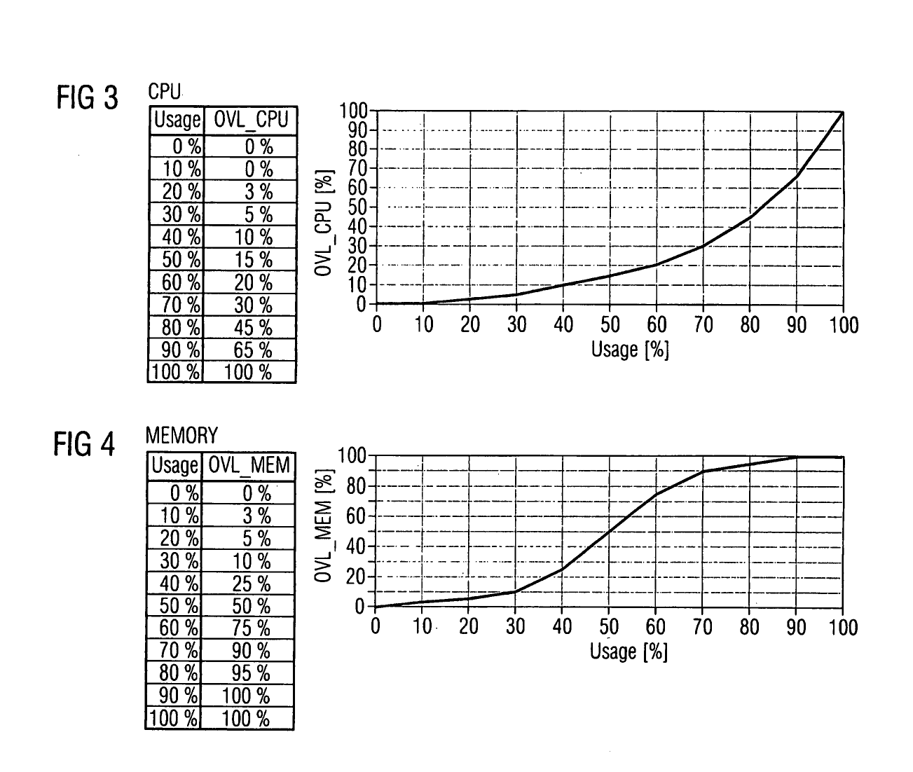

The CPU load level and its fuzzy equivalent level are shown in FIG. 3.

1.1.1.2.2 MEMORY (NOM/OOM)

The global MEMORY load (in opposition to the process memory occupancy) can be checked using standard OS functions or UMLA API. The returned value is a percentage of the whole MEMORY capacity (in a further step, it could be a per-cpu measurement in case of multiple CPU). Before using this raw measurement, it can be useful to go through an intermediate state, making the MEMORY raw measurement correspond to a MEMORY overload level (OVL_MEM). This intermediate statement is mostly useful if the NOM does not rely on Fuzzy Logic, indeed the FL performs automatically such conversions.

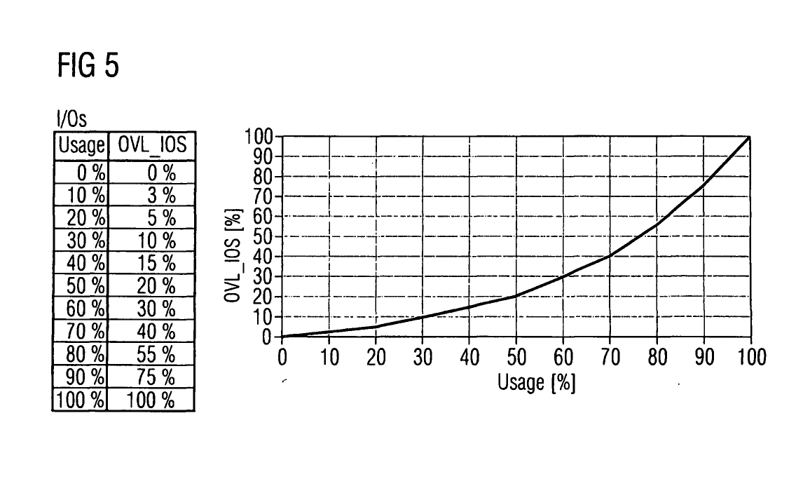

The memory charge level and its fuzzy equivalent level fur the COPL are shown in FIG. 4.

1.1.1.2.3 I/O (NOM/OOM)

The global I/O load (in opposition to the process memory occupancy) can be checked using standard OS functions or UMLA API. The returned value is a percentage of the whole I/O capacity (in a further step, it could be a per-cpu measurement in case of multiple CPU). Before using this raw measurement, it can be useful to go through an intermediate state, making the I/O raw measurement correspond to a I/O overload level (OVL_IOS). This intermediate statement is mostly useful if the NOM does not rely on Fuzzy Logic, indeed the FL performs automatically such conversions.

The I/Os usage level and its fuzzy equivalent level are shown in FIG. 5.

1.1.1.2.4 Overall System Overload (NOM/OOM)

Being interconnected to other telecommunication system components that interact with it, the COPL has to get information about the whole system health and communicate its own status to the rest of the system, if it enters an overload status.

For the LMP, it is important to keep informed about the overall overload situation of its connected neighbors inside the considered telecommunication system configuration. Overload Status Messages are supposed to be sent from the overloaded components to the COPL (belonging in the same way to the overall overload control system).

A kind of priority has to be defined within the LMP in order to react as a slave inside the overall overload handling of the telecommunication system. If the central call control enters the overload status 6, then it sends a message to the possibly responsible units in order to tell them to reduce the admission of new calls inside the system. This should also work specially in the case where the COPL hosts the PCU. The PCU can be at the origin of new call attempts. The PCU has to react on some congestion signals coming from the central call control system (EWSD CP). The COPL is notified via overload messages from the CP.

1.1.1.2.5 Applications Specific Resources (OOM Only)

Once the OOM is reached, it is compulsory to detect which part(s) of the whole system is (are) responsible for the overload situation. To reach this, one needs some applications specific resources monitoring. Most of the applications use the same kind of resources. We regroup these ones into five main types (similar to the ones in the LTG load control and related to the application configuration file within the UMLA):
communication blocks,
timer blocks,
heap blocks (UMLA: queues),
memory blocks (UMLA: pools),
transaction control blocks.

These resources can be controlled either by the UMLA and/or the OS. The LMP will then access the resources through one of them. The LMP may consider the overall consumption of these resources and determine the percentile use for each application. These common resources are essential for the well functioning of the COPL and the extent of their pools is designed to be sufficient. But their availability under heavy load must be monitored. This supervision is not meant to be a means for nicely tuned load regulation measures but it is an “emergency break”. They will be used for the determination of the application(s) responsible for the overload situation.

1.1.1.2.6 Transient Parameters (NOM/OOM)

These parameters are useful in order to avoid a too rapid reaction against local overload situations that are not significant and therefore must not start overload treatment procedures. It is still under analysis which form these parameters will take. The simplest form can be the tracing of the time interval since possible overload status entry. The next step is to tune this interval so that the system stays stable and reacts only on higher overload duration. A second form could be the derivation of the overload level over the time to determine if there is a possible prognostic to do with its evolution. These options have to be tested to determine which is the most optimal one for the considered scenario.

1.1.1.3The Normal Operation Mode (NOM)

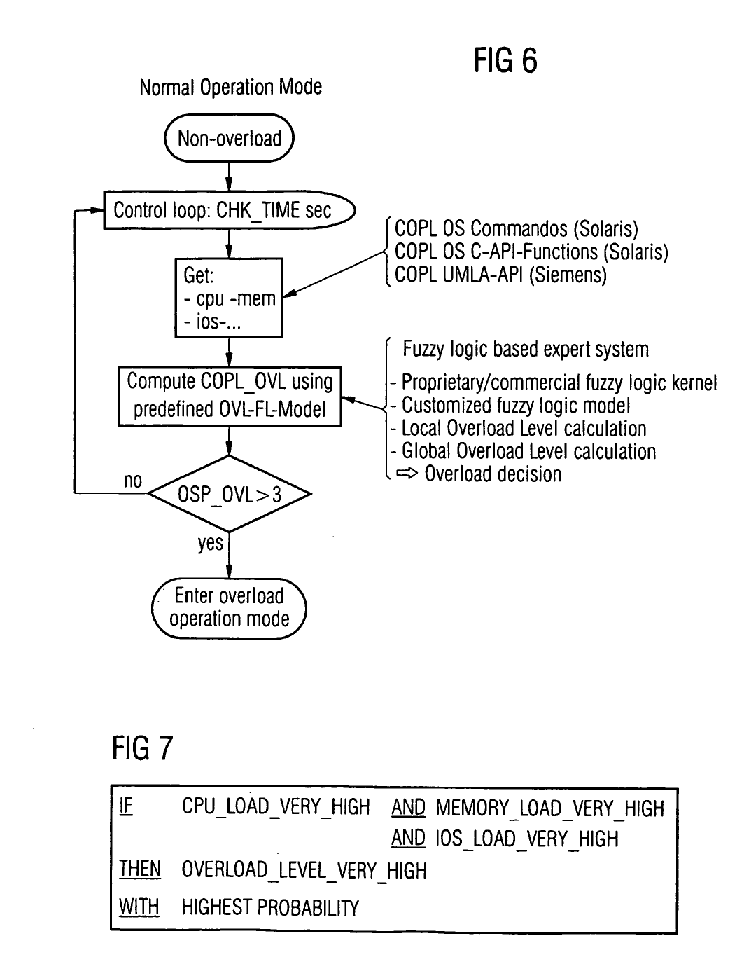

The NOM is in charge of controlling the (over-) load level during normal operation. According to the new calculated level, it eventually switches to the Overload Operation Mode (OOM). In order to make this level calculation, the NOM needs the in Error! Reference source not found. described inputs (only the system relative ones). Using the fuzzy logic descriptive model, it is easy to mix these inputs together and get the overload level using a set of basic rules. How the Fuzzy Logic is applied to NOM is illustrated in FIG. 6.

1.1.1.3.1 Overview of Fuzzy Logic Used in NOM

In NOM, every CHK_TIME sec, the predefined resources are checked (through COPL OS/UMLA) and are stored for following treatment. The next step consists in fuzzifying these crisp values into fuzzy variables. The sequence of fuzzy logic (inference) processing can be broadly divided into two functions: inference and defuzzification. The inference process begins with the processing of the production rules. Individual rules consist of a condition block (also called the antecedent or “IF” block) and a conclusion block (known as the consequent or “THEN” block). The inference process proceeds from the conditions to the conclusion, and then to the logical sum. To get a usable output, however, a deffuzifier operation must be performed to convert the fuzzy values back to a fixed, discrete output value, here the overload level for instance. An example for a typical rule example is given in FIG. 7.

All traditional logic operators (and, or, not, etc.) are available and also new ones that work only for fuzzy logic. Collecting such rules is easier than deducing complicated mathematical formulas that have to be re-engineered with the introduction of new variables in the system. The rules can be deduced from measurements and observations, using a quite straightforward intuitive deduction. For example, experience (thumb rules) in system tuning can be directly reused.

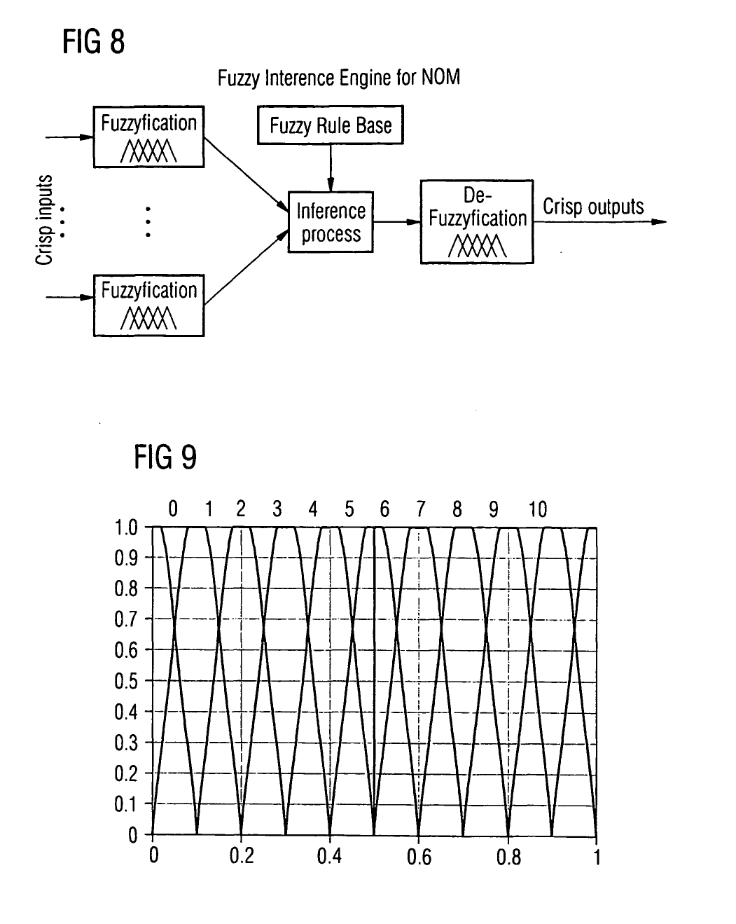

In the present embodiment hardware related requirements are imposed which cause the NOM to be platform specific rather than application specific. That means that only a part of the monitored resources will not be taken into account in the NOM fuzzy model. These remaining resources are to be used in the OOM anyway. The fuzzy kernel uses a fuzzy model definition file “overload_detection_model.fuz”. The NOM fuzzy inference engine is shown in FIG. 8.

1.1.1.3.2 Fuzzification Stage

A crisp input is a parameter coming from the monitoring system (cpu, memory, ios, CP-OVL), it is a number comprised in a predefined interval, for example for the cpu usage input parameter, the CPU crisp input is defined as a real number between 0 and 1 (or 0% and 100%). For this crisp input, a fuzzy variable has to be defined using “sets” of the fuzzy language. An example for fuzzy variable cpu sets is given in FIG. 9.

We define here eleven intensity levels of cpu usage (0 . . . 10), ranking from 0 to 1 for the crisp input parameter. For example, the definition of level 3 of cpu usage is defined through a trapeze starting by 20% climbing to the maximum of validity from 27.5%, staying at maximum till 32.5% and decreasing to zero by 40%.

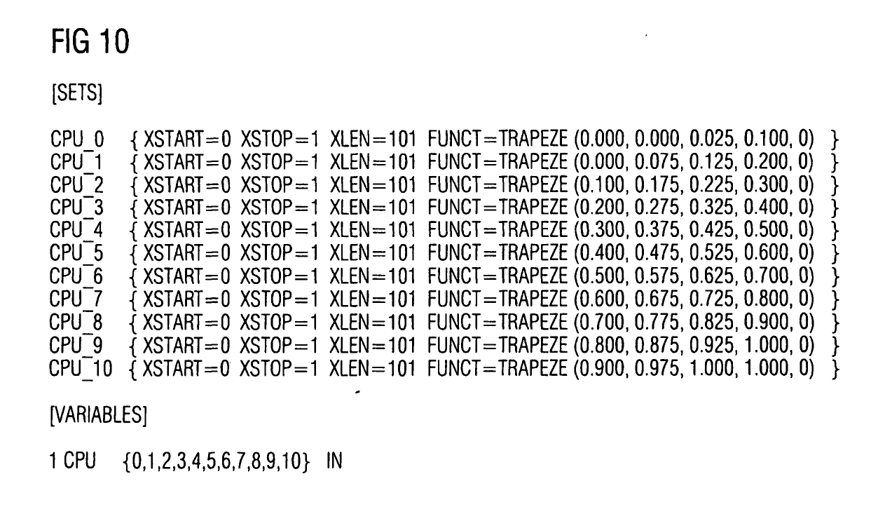

E.g. for an input cpu usage value of 25%, we say that the cpu usage fuzzy set 3 (level 3) is true with 65% validity. It is also the case for level 2, that means that, when cpu usage is equal to 25%, CPU is at the same time in level 2 and level 3 with 65% validity for each. The graphical representation of the CPU fuzzy variable corresponds to a part of the fuzzy model file. The definition of the CPU fuzzy variable using fuzzy sets is shown in FIG. 10.

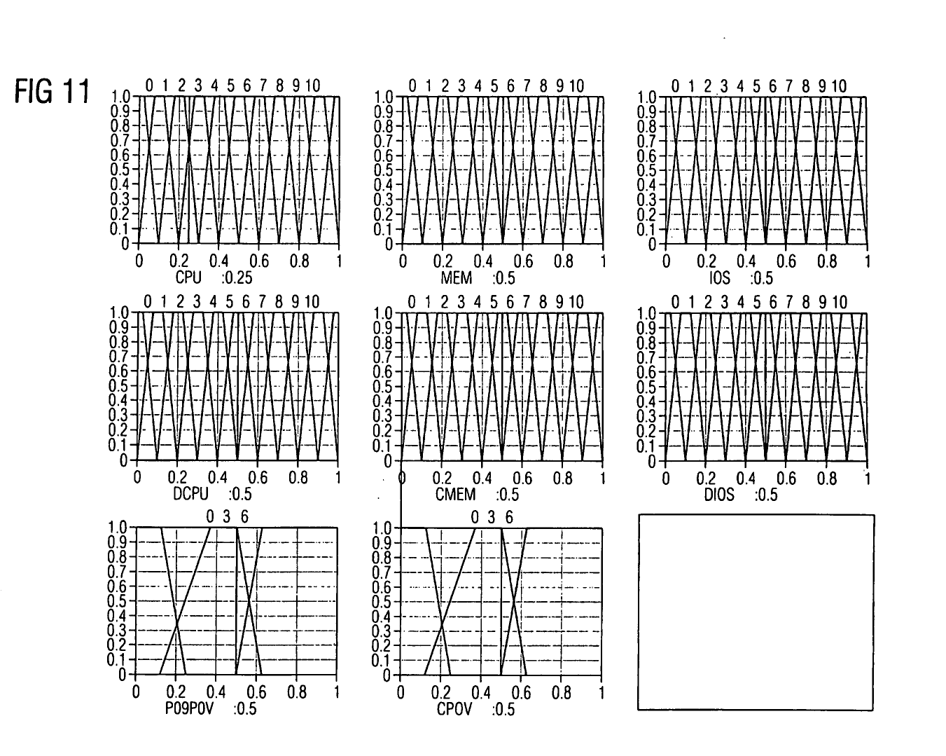

Extracting the validity of each fuzzy set for each variable according to its crisp value is called “Fuzzification” of the input crisps. NOM fuzzy variables are shown in FIG. 11.

Once all input crisps have been fuzzified, the inference process is entered.

1.1.1.3.3 Inference Process

The inference process reads the fuzzy rule base and evaluates its contained rules according to the fuzzy sets coming from the fuzzification stage. These rules look quite similar to standard logic rules. Like we described them in Error! Reference source not found., the fuzzy rules are build following the well-known IF THEN construction. Where the difference between standard (Boolean) logic and fuzzy logic takes place, it is in the values taken by the operands and the mathematical definition of the operators. Where “true” (1) and “false” (0) are the only possible values for operands in standard logic, the fuzzy logic allows operands to take continuous or discrete values between 0 and 1 (in its normalized form). Some logical operators are defined in the standard logic and also in the fuzzy logic:

| | | | |
|---|---|---|---|
| NOT | ! | [symbol] | − |
| AND | & | [symbol] | · |
| OR | \| | [symbol] | + |
| XOR | | | ⊕ |

A characteristic of the fuzzy logic operators is the possibility to change their mathematical definition according to the context:
A AND B=MIN(A,B) but also A AND B=ALGP(A,B) (algebraic product)
A OR B=MAX(A,B) but also A OR B=ALGS(A,B) (algebraic sum) NOT A=1−A
   According to these definitions, it is understandable how fuzzy logic allows logic with values between 0 and 1 (and not only 0 or 1). Again the very true rule (Error! Reference source not found.):
   Lets say that if CPU_LOAD_VERY_HIGH=0.7 (after fuzzification), MEMORY_LOAD_VERY_HIGH=0.5, IOS_LOAD_VERY_HIGH=0.9,
   then the assessment
IF CPU_LOAD_VERY_HIGH AND MEMORY_LOAD_VERY_HIGH AND IOS_LOAD_VERY_HIGH THEN OVERLOAD_LEVEL_VERY_HIGH WITH HIGHEST PROBABILITY
   becomes, if we take MIN as AND operator definition,
OVERLOAD_LEVEL_VERY_HIGH is true with 50% (=min(0.7,min(0.5,0.9))×1.0)

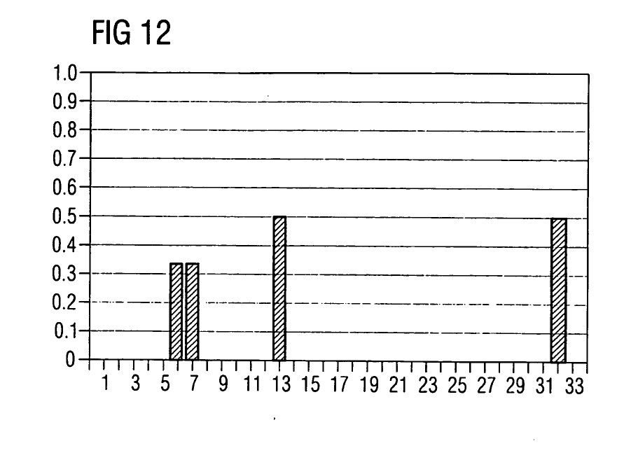

The output of all the rules within the fuzzy model is shown in FIG. 12.

When all rules have been calculated, the resulting sets of the output variable have to be “accumulated”. This is done by composing all the sets together using an “accumulation” operator, like the logical sum (max operator).

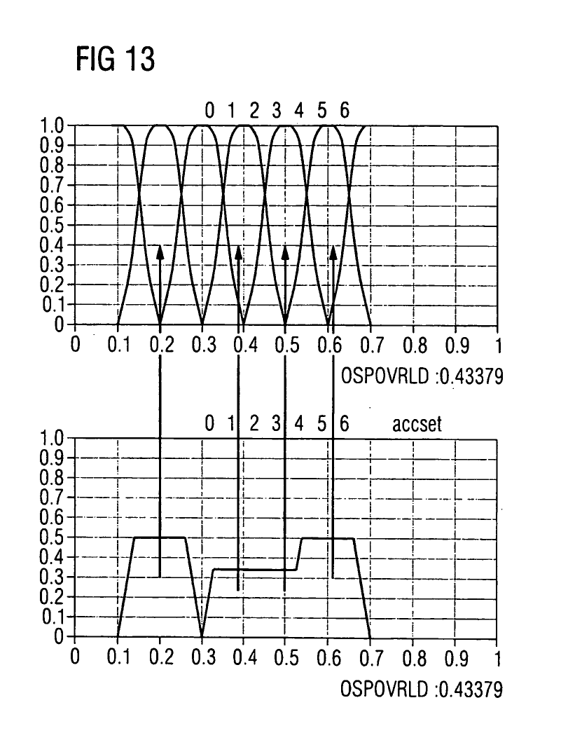

The result of this operation can be seen in the lower part of FIG. 13. One can see that the different rules (here only given as example in Error! Reference source not found.) that generate the output result.

1.1.1.3.4 Defuzzification

The last step performed by the fuzzy logic kernel within the NOM is the deffuzification. As we have seen in the previous step, the fuzzy logic delivers an output result in form of a graph (Error! Reference source not found.). This result is not immediately usable in this form, it needs to converted into a crisp value to be exploitable in the rest of the NOM.

Again, it is possible to use diverse methods or operators to get a crisp value out of the resulting curve. Possible operators are the COG (center of gravity), the MAXMAX (maximum of maximums). Here we propose to use the COG. This operator permits taking into account all the results of all the rules, where the MAXMAX is a pessimistic operator. The COG operator search the center of gravity of the surface between zero (y axe) and the resulting curve from the inference step. In our example, the COG is 0.4. With MAXMAX we would have got 0.65 (this does not take into account the result of some rules, giving also a result around 0.2 and 0.4).

Further investigations have to be done in order to determine the best-suited operator for the deffuzification.

1.1.1.3.5 COPL Overload Level

The value delivered by the fuzzy logic model of the NOM ranks from 0 to 1; so that if we want to stay compatible with the CP/LTG-Overload levels, we must re-scale from [0:1] to [0;1;2;3;4;5;6].

The fuzzy logic model is designed to run with a limited amount of sets for a given variable. If we consider the output variable COPL_OVL having 7 sets: 0,1,2,3,4,5,6, then we can get the overload level by fuzzifying the crisp into sets validity and then take the maximum validity.

The other method is to re-scale linearly from 0:1 to 0;1;2;3;4;5;6. This solution should be taken only in the case of cpu resource shortage. Indeed it is not as efficient as the first solution.

1.1.1.4The Overload Operation Mode (OOM)

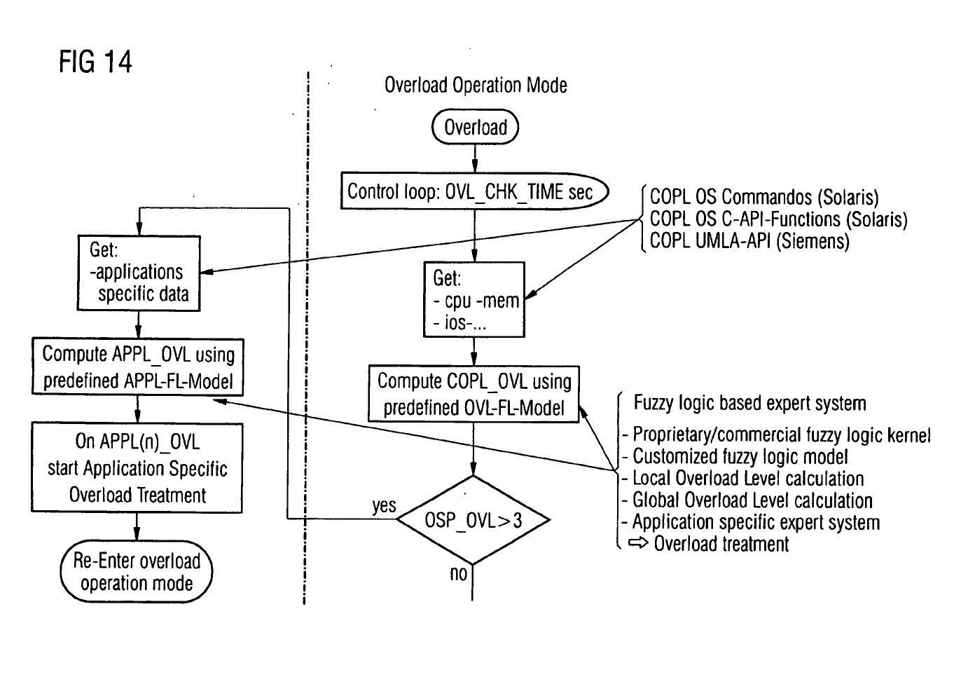

If the NOM detects an overload level superior to a given threshold, it switches to the Overload Operation Mode (OOM) in order to determine the reactions needed to return to the Normal Operation Mode (NOM). Within the OOM, measurements are made (resource checking) and combined to determine which process or application has to be reduced, alarmed or made aware of the overload situation. The application of Fuzzy Logic to OOM is shown in FIG. 14.

1.1.1.4.1 Overview of Fuzzy Logic Used in OOM

The general function of the fuzzy logic in the OOM is similar to the one for the NOM. Only the time interval, the variables checked and the output treatment are different. Once the OOM is entered, the time interval between two overload checks (OVL_CHK_TIME) is smaller than the one used by the NOM (CHK_TIME). This ensures a quicker return to the NOM if no more overload is present.

The same fuzzy core functions and interfaces are used. The fuzzy kernel takes a fuzzy model definition file “overload_treatment_model.fuz”:
the input variables encompass the ones of the NOM and some application specific resources,
the output variables define again the overload level for the whole COPL but also application specific overload levels (degree of action to be taken for this particular application),
the COPL overload level is calculated at that step.

The aim of the fuzzy logic in the OOM is to determine a level of overload or responsibility for overload per application/process and also the COPL overload level again. The application/process overload levels will be further used by the Overload Treatment Process (OTP).

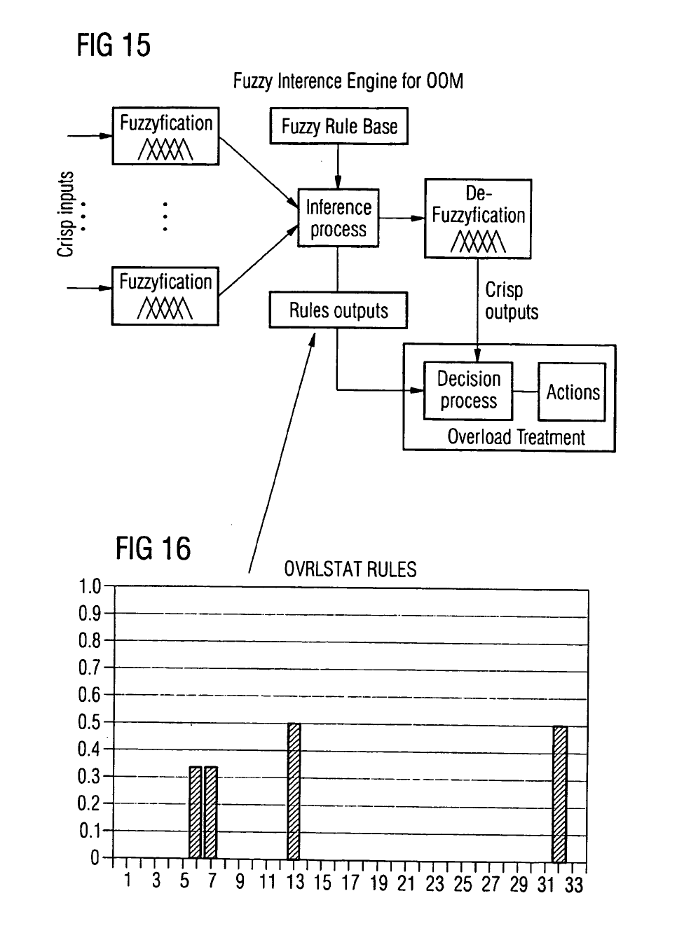

In FIG. 15 the fuzzy inference engine used for the OOM is shown.

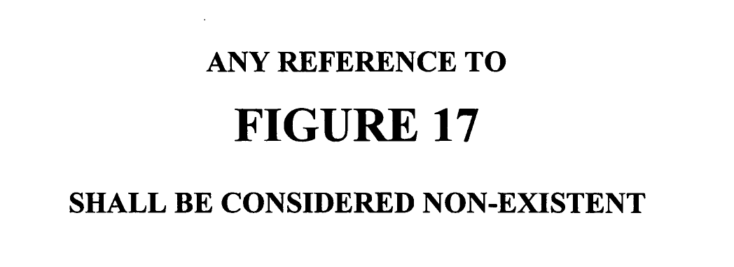

After the Inference Process step, it is possible to extract rules validity as shown in FIG. 16.

These values (or a part of them) will be transmitted to the OTP for further treatment. It is not the usual step that is used for a fuzzy logic expert system. But during the study it appeared to be a good solution to help the OTP program to take some decisions. This rules validity is kept in order to be mixed with the results coming from the defuzzification step.

1.1.1.4.2 COPL Overload Level

The same remarks as for Error! Reference source not found. apply.

There are two alternatives in how to proceed: we can use the results of the application specific overload calculation by calculating the COPL overload level at that step or we can re-use the NOM fuzzy model to control again the resources.

1.1.1.4.3 Application/Process Specific Overload Level

Each application/process that runs on the COPL needs three blocks to be integrated into the Overload Management System:
dedicated routines to check its specific resources status,
an associated fuzzy logic variable (definition of sets),
a set of rules leading from these resources to a specific overload level.

Depending on the chosen programming technique, these blocks can be integrated either offline or online (database). This issue is open and is not in the scope of this document.

1.2 Overload Treatment

After the Overload Detection, Overload Treatment has to be started in order to come back to a non-overloaded situation. The Overload Detection and its associated components deliver a COPL Overload Level, application/process specific Overload Levels and overload rules validity values to the Overload Treatment (OT) program.

According to these inputs, the OT has to decide actions to be taken in order to bring the system back to its normal status. To do this, the OT has to start actions locally (within the COPL) and/or remotely by sending overload messages to the connected equipment.

All actions taken locally belong to the Local COPL Overload Treatment (Error! Reference source not found.). The other actions depend on the communication of the COPL Overload Level to the other platforms (Error! Reference source not found.).

1.2.1 Local COPL Overload Treatment

The Local COPL Overload Treatment is in charge of taking actions to reduce overload locally on the COPL itself and communicating its overload status to other connected platforms to first avoid new incoming traffic and second inform the system.

1.2.1.1 Overload Treatment Process (OTP)

The Overload Treatment Process and its subsystems drive all these features. Four types of mechanisms participate to the OTP:
1. Decision of the actions to be taken,
2. Active or direct local overload reduction,
3. Passive or indirect local overload reduction,
4. Passive or indirect remote overload reduction.

Mechanism 1 and 2 take place in the Overload Treatment Reduction Process. Mechanisms 2 and 3 take place in the Overload Treatment Communication Process (external and internal stages). Details of how the overload treatment process operates on the COPL are shown in FIG. 1.

1.2.1.1.1 Overload Treatment Reduction Process (OTRP)

1.2.1.1.1.1 Overload Treatment Identification

This process first decides which actions (and action types) have to be taken according to the diverse overload levels and rules validity it becomes from the Load Monitoring Process (LMP). We mean actions here as active or passive, local or remote, increasing or decreasing.
Active action: action that acts directly through the OS or the UMLA on applications,
Passive action: action that acts indirectly through a common interface (thresholds in a self-controlled-standalone-application),
Local action: action acts local on the COPL,
Remote action: action sends messages through interfaces to external platforms/process,
Increasing action: action allows more resource consumption,
Decreasing action: action restricts resource consumption.

Then the OTRP starts the needed overload treatment mechanisms. The OTRP treats itself the local active actions and delegates all the other actions to the Overload Treatment Communication Process (OTCP).

The reason of this separation between OTRP and OTCP is that local active actions distinguish themselves from other ones by their mechanisms; they do not communicate with the concerned application/process but act directly on it through the OS or the UMLA (for example by reducing the allowed amount of cpu time or memory or blocking their communication with the network communication stacks).

The OTCP communicates either locally with COPL hosted applications/processes using messages and/or threshold variables or remotely with other platforms and applications using the messaging system.

1.2.1.1.1.2 Internal Strategies of Load Rejection and Reduction

The fuzzy logic expert system of the OTP enables classes of services/processes to be defined. This means that different priorities can be given to the applications/processes running for the COPL.

1.2.1.1.1.2.1 Load Reduction

Internal strategies of load reduction are in that case strategies of attribution (or distribution) of resources to applications/processes according to their overload status and their pre-defined priorities.

CPU, MEMORY and IOS are shared by these applications/processes. It is possible to change the repartition or attributed amounts of these resources for each application through either the OS or the UMLA. If the action takes place without alerting the application with messages, then it belongs to the OTRP, if messages are sent, then it belongs to the OTCP.

If a given application/process has reached a critical overload level and other applications have been given amounts of resources they do not use at that precise time, then a good strategy is to give these resources to the overloaded application/process so that it can accomplish its task and return to a normal load situation. As soon as this is done, the re-routed resources can be given back to their owners.

That means that in overload status, a dynamic resource sharing can be achieved, and that the repartition is done by the fuzzy logic expert system.

1.2.1.1.1.2.2 Load Rejection

Internal strategies can also include load rejection actions. These is done by disabling the upcoming service requests. These strategies have to be identified in the next parts of this document (application by application).

If the load rejection action takes place in the COPL without alerting the application with messages, then it belongs to the OTRP, if messages are sent, then it belongs to the OTCP.

1.2.1.1.2 Overload Treatment Communication Process (OTCP)

This process is in charge of relaying the overload treatment actions (decided in the OTRP) to local or remote applications/processes/equipment using system messages. These messages can be sent using the UMLA and/or other communication protocols, depending on the destination.

The applications/processes addressed by the OTCP can be of two types, local or remote. Local means here that they run directly on the COPL itself and remote means that they run on some separate equipment and can be commanded through some management protocols.

1.2.1.1.2.1 Communicating Overload Level to COPL Applications

There is an active way of informing applications about changes of the overload level by event and a procedural interface that makes the overload levels available.

The exact mechanism (message type, interface and procedure) has to be defined for each application or process. The diversity of applications, processes and their manufacturer does not allow a common treatment. That is the reason why the overload treatment has to be federate into a single control system that then decides and distributes overload rejection/reduction actions.

Possible means to achieve the communication of the overload levels and actions to the applications and processes are:
messaging interface,
UMLA API,
Open Third Party APIs,
Network Management Protocols (SNMP . . . ).

All these options will be discussed in dedicated paragraphs for the OSP and the PCU.

1.2.2 Communicating Overload Level to Other Platforms

For several load control related purposes load levels need to be distributed by COPL load control to others but the own platform.

Possible means to achieve the communication of the overload levels and actions to the applications and processes are:
messaging interface (LTG, EWSD, Proxies),
Network Management Protocols (SNMP . . . ).
   1.2.3 Applications Overload Treatment

Each time possible, the applications should have a kind of integrated Call Admission Control that checks the last known overload status.

This overload status can be different for each application, forcing it to react differently against the load situation. This allows a higher flexibility for the overload treatment mechanisms.

Depending on the inter-process communication capabilities of the considered application, its dedicated overload status will be delivered to it (OTP/OTRP or OTCP) or will be available for polling from the OTP (OTCP).

According to its overload level, the application can drive different strategies, like delaying or refusing new incoming requests.

The new incoming requests should be stopped, when possible, not in the application itself, but in the processes that are at the beginning of the call/request processing. But, if these processes are used from other applications that are not in an overload situation requiring some overload treatment, then the new incoming requests have to be stopped at the next level, after leaving these processes and before arriving at the considered application. This is done by configuring the fuzzy expert system with the correct set of rules.

### EXAMPLE

For the CtD application, new incoming requests should be stopped already within the PINT+ GW Application by setting the overload level of the PINT+ GW Application high enough to stop processing of new incoming requests.

If the PINT+ GW Application is shared by other applications than the CtD application and these applications have a higher service priority level, then the overload level of the CtD application shall be set so that it does not authorize new sessions and the PINT+ GW application shall stay as before.

Concretely, if the NOM detects an overload situation, it enters the OOM. The OOM then tests the overload status of the CtD application and the PINT+ GW application. If the CtD application is the only connected application to the PINT+ GW (see Rule 1), then the PINT+ GW application gets a higher overload level and starts rejecting new incoming requests. If the CtD application shares the PINT+ GW with other applications having a higher priority level (see Rule 2), then it becomes itself a higher overload level and starts itself rejecting new session attempts.

It can be translated into two fuzzy logic rules:

Rule 1:

IF OSP_OVERLOAD_HIGH
AND CTD_ACTIVE_SESSIONS_HIGH
AND (NOT PINT+ GW_SHARE_HIGH)
THEN PINT+ GW_OVERLOAD_LEVEL_HIGH
   Rule 2:
IF OSP_OVERLOAD_HIGH
AND CTD_ACTIVE_SESSIONS_HIGH
AND PINT+ GW_SHARE_HIGH
THEN CTD_OVERLOAD_LEVEL_HIGH.
   4. Advantages of the Invention

Here we develop control mechanisms and policies such that the COPL (i) tracks and avoids non-manageable overload situations before they set in (predictive fuzzy logic rules in the NOM), (ii) avoids ado short overload picks (transient fuzzy logic rules in the NOM), and (iii) provides service differentiation between different applications based on specified policies (application specific fuzzy logic rules in the OOM).

With such support a server becomes self-sufficient in preventing overload and can dynamically configure the control mechanisms provided to obtain the desired performance effects. One of the advantages of this approach is that no additional or new equipment needs to be deployed separately to provide similar capabilities.

Further, this permits existing server installations to be upgraded in an application and network transparent manner, i.e., without deeply modifying applications or existing network connectivity.

Another significant advantage is that the control settings provided can be used to track an overload situation as it unfolds, generating notifications or control actions as necessary. This greatly simplifies administration and capacity planning for a server, and by extension for a server farm, thereby reducing system management costs and complexity. This is also applicable to proxies, front-end servers, . . .

The provided fuzzy logic programming language authorizes all levels needed for a precise tuning of the overload handling. There is no limit for the granularity of the overload decision and overload treatment models.

Furthermore, the idea to use the results of the rules calculation in combination with the output variables calculation allows a simple description of overload actions to be specially taken. Because a rule describes a precise mix of overload conditions like common resources overflow, application specific queues overflow, this same rule can be taken as decision base for overload handling actions. Every new recognized overload situation can be introduced in the fuzzy logic expert system database and actions can be taken according to it.

The proposed fuzzy logic toolbox allows giving different priorities to the rules used for the overload status calculation. This permits different levels of precision in the overload calculation. More important rules get a higher priority factor.

The proposed fuzzy logic toolbox also allows also dynamic changes. That means, it is possible to couple it to self-learning mechanisms like neuronal networks in order to develop a self adaptive overload control expert system.

5. Example(s) of the Invention.

Intelligent Load Control for the OSP/PCU/ESUN in SURPASS
Intelligent Load Control for WebServers
Centralized differentiated QoS aware Call Admission Control for new Soft switches.

1-7. (canceled)

8. A method for controlling overload of a data processing system, comprising:
monitoring a load of the data processing system, wherein parameters for a degree of utilization of resources of the data processing system are determined;
running an overload operation mode of the data processing system;
feeding the parameters into a fuzzy logic expert system, which comprises a fuzzy rule base having rules and associated fuzzy logic variables;
identifying important rules among said rule base in acordance with the parameters via the fuzzy logic expert system;
calculating values for the fuzzy logic variables, which are associated with the important rules; and
handling the overload based on the identified rules and the calculated values of the associated fuzzy logic variables.

9. The method according to claim 8, further comprising:
running a normal operation mode of the data processing system.

10. The method according to claim 9, further comprising:
monitoring the load of said data processing system;
determining parameters for said degree of utilization of resources of the data processing system in both the normal operation mode and the overload operation mode;
feeding the parameters into the fuzzy logic expert system;
determining additional application specific parameters, which refer to the degree of utilization of resources by applications running on the data processing system, in the overload operation mode; and
feeding the application specific parameters into the fuzzy logic expert system.

11. The method according to claim 10, further comprising:
determining an overload level via said fuzzy logic expert system based on the parameters and/or the application specific parameters; and
using the overload level as criterion for switching between the normal operation mode and the overload operation mode.

12. The method according to claim 8, wherein the monitoring of teh load of said data processing system is performed according to a clock rate, which is higher in the overload operation mode than in the normal operation mode.

13. The method according to claim 9, wherein the monitoring of the load of said data processing system is performed according to a clock rate, which is higher in the overload operation mode than in the normal operation mode.

14. The method according to claim 10, wherein the monitoring of the load of said data processing system is preformed according to a clock rate, which is higher in the overload operation mode than in the normal operation mode.

15. The method according to claim 8, wherein the degree of utilization of at least one of the following resources is monitored: CPU load, memory utilization, I/O load.

16. The method according to claim 9, wherein the degree of utilization of at least one of the following resources is monitored: CPU load, memory utilization, I/O load.

17. The method according to claim 10, wherein the degree of utilization of at least one of the following resources is monitored: CPU load, memory utilization, I/O load.

18. The method according to claim 11, wherein the degree of utilization of at least one of the following resources is monitored: CPU load, memory utilization, I/O load.

19. The method according to claim 12, wherein the degree of utilization of at least one of the following resources is monitored: CPU load, memory utilization, I/O load.

20. The method according to claim 8, wherein the method is performed by a data processing system.

21. A method for controlling overload of a data processing system, comprising:
monitoring a load of the data processing system,wherein parameters for a degree of utilization of resources of the data processing system are determined;
feeding the parameters into a fuzzy logic expert system, which comprises a fuzzy rule base having rules and associated fuzzy logic variables;
identifying important rules among said rule base in accordance with the parameters via the fuzzy logic expert system;
calculating values for the fuzzy logic variables, which are associated with the important rules; and
handling the overload based on the identified rules and the calculated values of the associated fuzzy logic variables.

22. The method according to claim 21, wherein the degree of utilization of at least one of the following resources is monitored: CPU load, memory utilization, I/O load.

23. The method according to claim 21, wherein the method is performed by a data processing system.

24. A data processing system, comprising a mechanism for performing a method for controlling overload, the method comprising:
monitoring a load of the data processing system, wherein parameters for a degree of utilization of resources of the data processing system are determined;
running an overload operation mode of the data processing system;
feeding the parameters into a fuzzy logic expert system, which comprises a fuzzy rule base having rules and associated fuzzy logic variables;
identifying important rules among said rule base in accordance with the parameters via the fuzzy logic expert system;
calculating values for the fuzzy logic variables, which are associated with the important rules; and
handling the overload based on the identified rules and the calculated values of the associated fuzzy logic variables.
